(19) United States
(12) Patent Application Publication
(10) Pub. No.: US 2006/0009054 A1
(43) Pub. Date: Jan. 12, 2006

(54) Cable connection assembly

(75) Inventors: Gilles Avignon, La Celle St Cloud (FR); Xavier Gaillard, Le Pecq (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/166,245

(22) Filed: Jun. 27, 2005

(30) Foreign Application Priority Data
Jul. 8, 2004 (EP) 04291726.0

(51) Int. Cl. H01R 4/58

(52) U.S. Cl. 439/88

(57) ABSTRACT

A cable connection assembly for connecting a cable (1) to a connection point (5), wherein a conductor part (11) of the cable is connected to a connector element (2) and the connector element (2) is adapted for mechanically engaging to said connection point (5). A charged elastomer material (3) is disposed on said connector element (2) or on the connector element and the conductor part (11) substantially covering the connector element (2), or the connector element (2) and the conductor part (11), for absorbing parasitic interference from the connector element (2) or the connector element and the conductor part (11). Electrical current induced in the elastomer material by said absorbed parasitic interference is drained off to a the mass through a shield.

This application is based on, and claims the benefit of, European Patent Application No. EP 04291726.0 filed on Jul. 8, 2004, which is incorporated by reference herein

The present invention relates to an assembly for connecting the end of a cable to a connection point is such a manner that parasitic interference is substantially absorbed and preferably drained off to a ground, this being that such that while electrical continuity to the mass is ensured between the shield and the cable end, parasitic interference is avoided.

### BACKGROUND OF THE INVENTION

Recently there has been a strong integration between telecommunications equipment with parts that are involved in IF, RF, power supply applications and/or other high frequency or high voltage applications. Such applications frequently generate parasitic interferences that require solutions towards attenuating and absorbing them into the mass. This is especially the case in relation to products that are of a reduced size, which at present constitute a general trend in manufacturing.

The term “mass” in this specification is to be understood to relate to electrical earth or ground in an equipment.

As it is well known, in a simplified manner, cables can be described to be typically formed by an elongated conductor part, usually of metal, which can undertake a variety of forms. Many cables have in addition an insolating part, often referred to as jacket, for covering around the conductor part and in this manner providing protection as well as electrical insulation.

In certain equipment such as those mentioned above for use in telecommunications for high voltage connections or high frequency communications, shields are used in particular in the vicinity of a connection point where a cable is connected to the mass. A shield is a conducting envelope, usually fabricated from a metallic braid, foil or the like, surrounding the cable or an area where the cable is present. A shield acts as a barrier to the passage of interference caused by electrostatic or electromagnetic fields which are generally not desirable. In particular shields can be connected to the mass, in order to drain off current caused by any parasitic interference.

Currently when a cable is connected to a connection point, the general practice involves stripping the conductor part of the cable end and binding it to the neighboring mechanical pieces of the equipment. The binding is done by using fastening means such as screw or adhesive ribbon.

As regards the attenuation or suppression of the parasitic interference, in the known techniques protective films are used to cover the conductor part of the cable and in this manner when the latter part is engaged, through an opening of a connection point in the surrounding mechanical pieces, the protective films cover the assembly in order to block the parasitic interferences.

A problem associated with the above known solution is that the structure as such for obtaining electrical continuity to the mass requires mechanical fixations and as a result substantial supplementary manufacturing and fixing equipment is needed. Another drawback of the known solution is the risk of damaging the cable because the process of connecting involves the pinching of the cable.

As regards the suppression of parasitic radiation, the protective films are put in place using adhesive tapes and the process requires cutting and a more or less random positioning of the films because the shape of the conductor end of the cable and the connectors are not necessarily in conformance with each other and as a result certain parts of the conductor part may not be suitably covered so as to prevent parasitic interference.

### DESCRIPTION OF THE INVENTION

The above drawbacks are overcome by using the solution proposed by the present invention according to which mass continuity and interference suppression are achieved using an over-mould cover at the conductor end portion of the cable or over a connector attached to said conductor end portion. The over-mould cover is made of an elastomer material charged with electrically conductive particles, which on the one hand provides electrical continuity to the mass, and on the other, prevents parasitic interference.

Accordingly one object of the present invention is that of providing a cable connection assembly for connecting a cable to a connection point, the cable comprising a conductor part for connection to a connector element, the connector element adapted for mechanically engaging to said connection point, characterized in that a charged elastomer material is disposed on said connector element or on the connector element and the conductor part, such that said elastomer material substantially covers the connector element, or the connector element and the conductor part, for suppressing or substantially attenuating parasitic interference from said connector element or the connector element and the conductor part.

According to an aspect of the invention, the charged elastomer material is adapted for entering into physical contact with a shield and providing electrical continuity with said shield.

According to a further aspect of the invention, said suppression or attenuation of parasitic interference is done by said charged elastomer by absorbing electromagnetic radiation or electrostatic interference from said connector element or said conductor part.

According to another aspect of the invention, said charged elastomer is adapted for draining off electrical current induced by the absorption of said parasitic interference, through said shield to a mass.

According to yet another aspect of the invention, said charged elastomer material is disposed on said connector element or on the connector element and the conductor part by over-molding.

According to still another aspect of the invention, said charged elastomer material comprises particles of nickel and graphite in a proportion according to the desired level of attenuation.

These and further advantages of the present invention are explained in more detail in the following description as well as in the claims with the aid of the accompanying drawings.

### BRIEF DESCRIPTION OF THE DRAWINGS

FIG. 1a is an upper view of an example of a cable connection assembly according to the present invention.

FIG. 1b is a simplified cross -sectional view of the connection assembly of FIG. 1a as viewed along the line A-A.

FIG. 2 is a simplified cross-sectional view of the connection assembly of FIGS. 1a and 1b with the connection assembly engaged to a connection point.

### EXAMPLE OF A PREFERRED EMBODIMENT

In all figures, for the sake of simplicity of discussion, only the parts and elements that are needed for a better understanding of the description of the invention are shown. Therefore, unnecessary details of the assembly are eliminated in the drawings.

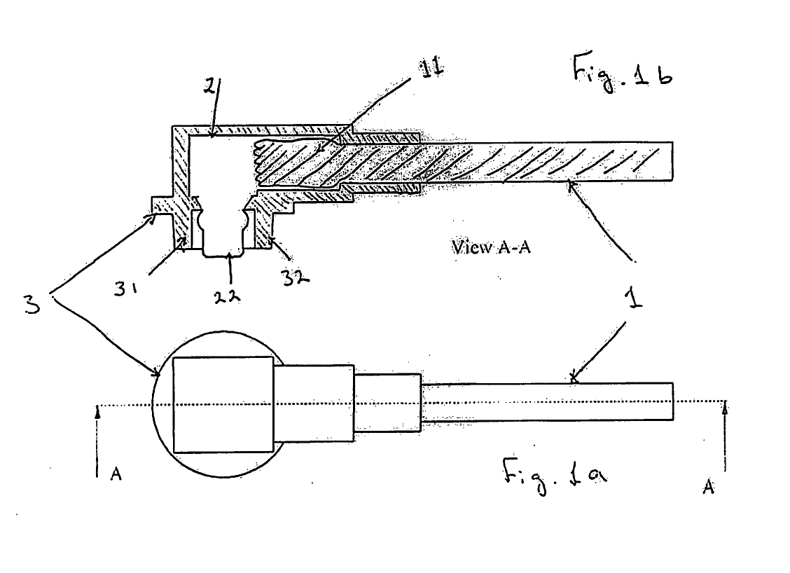

FIGS. 1a and 1b will be described together as they relate to different views of the same object. FIG. 1 a is an upper view of an example of a cable connection assembly according to the present invention and FIG. 1b is a simplified cross-sectional view of an example of a connection assembly as viewed along the line A-A of FIG. 1a. In FIGS. 1a 1b, a cable 1 is shown having a cable end 11. The cable end 11 is introduced into a connector device 2 of a known type through an opening 21 thereof.

According to the invention, the end portion of the cable 11 together with a portion of the body of the connector device 2 are covered with a charged elastomer material 3. An elastomer is understood to be any type of polymer having elastic properties resembling rubber. Some known examples of elastomers are silicon and nytril. A charged elastomer is one which comprises particles that are electrically conductive, for example nickel and graphite may be used together in a charged elastomer. Other types of particles known in the art such as silvered aluminum or copper may also be used. The proportion of these particles in the material is decided as a function of the desired attenuation of the parasitic interference.

The elastomer material is disposed over the connector 2, or the connector 2 and the cable end 11, by over-molding process. Over-molding is a known process in the related art. According to this process, the cable is introduced in a mould which contains cavities. After closing the mold, the elastomer is injected therein by pressure. The elastomer fills the cavity around the connector. Some seconds later the mould is opened and the over-molded cable is thus obtained.

As a result of the over-molding, the elastomer surrounds the connector 2, and if needed the cable end 11, leaving only a passage open close to the connector head 22. In FIG. 1b, this passage is shown as an open space between the end portions 31 and 32 of the elastomer material. This passage provides an opening intended for plugging of the connector head 22 to a connection point.

In use, the charged elastomer material absorbs parasitic interferences such as electromagnetic radiation or electrostatic interference generated at the connector 2 or the cable end 11. The absorption of the parasitic interference gives rise to induction of an electrical current which is then preferably drained off as will be discussed below.

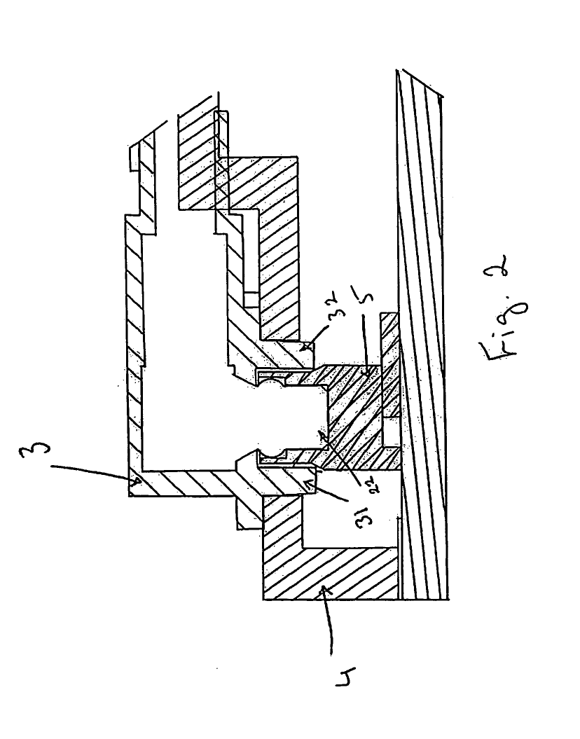

Referring now to FIG. 2, the connection assembly of the present invention is shown in plugged position. For the sake of simplicity of the drawing, the cable is not shown in the figure. During the plugging of the connector 2, the connector head 22 is plugged into the connection point 5 providing electrical contact. At the same time, the end portions 31 and 32 of the elastomer material 3 enter in contact with the shield 4 ensuring a firm mechanical engagement as well as electrical continuity from the elastomer material to the shield. Due to the existence of electrical continuity, electrical current induced in the charged elastomer as a result of absorbing parasitic interference can be conducted to the shield. As a result, the shield is used for draining off the induced current to the mass. In this manner, all the parts that could produce parasitic interference are substantially blocked and the radiation absorbed by the elastomer material is drained off.

It is to be noted that the level of blockage of the parasitic interference can be changed according to the requirements. Thus while a substantially complete blockage can lead to a suppression of all parasitic interference, a partial blockage can lead to only an attenuation of such interference. The elastomer material is thus chosen as a function of said requirements.

It is further to be noted that the elastomer material can be disposed to cover more or less portion of the connection assembly as desired, for example it can cover only the connector or both the connector and the conductor part of the cable and the coverage can be done in different extensions thereof.

In this manner, the two requirements of providing electrical continuity to the mass and blocking of parasitic interference are ensured without a need for complicated implementations to be done by persons in charge of the assembly. Furthermore, using the solution of the present invention avoids the risk of damaging the cables due to pinching.

1. A cable connection assembly for connecting a cable (1) to a connection point (5), the cable comprising a conductor part (11) for connection to a connector element (2), the connector element (2) adapted for mechanically engaging to said connection point (5), characterized in that a charged elastomer material (3) is disposed on said connector element (2) or on the connector element and the conductor part (11), such that said elastomer material (3) substantially covers the connector element (2), or the connector element (2) and the conductor part (11), for suppressing or substantially attenuating parasitic interference from said connector element (2) or the connector element and the conductor part (11).

2. A cable connection assembly according to claim 1, wherein the charged elastomer material is adapted for entering into physical contact with a shield and providing electrical continuity with said shield.

3. A cable connection assembly according to claim 1, wherein said suppression or attenuation of parasitic interference is done by said charged elastomer by absorbing electromagnetic radiation or electrostatic interference from said connector element or said conductor part.

4. A cable connection assembly according to claim 2, wherein said charged elastomer is adapted for draining off electrical current induced by the absorption of said parasitic interference, through said shield to a mass.

5. A cable connection assembly according to claim 1, wherein said charged elastomer material is disposed on said connector element or on the connector element and the conductor part by over-molding.

6. A cable connection assembly according to claim 1, wherein said charged elastomer material comprises particles of nickel and graphite in a proportion according to the desired level of attenuation.
